(19) United States
(12) Patent Application Publication
(10) Pub. No.: US 2015/0141233 A1
(43) Pub. Date: May 21, 2015

(54) Adapter For A Centrifuge Vessel

(71) Applicant: Thermo Electron LED GmbH, Langenselbold (DE)

(72) Inventor: Norman Ballhause, Windhausen (DE)

(21) Appl. No.: 14/413,284

(22) PCT Filed: Jul. 8, 2013
(86) PCT No.: PCT/EP2013/002011

§ 371 Date: Jan. 7, 2015

(30) Foreign Application Priority Data
Jul. 9, 2012 (DE) 10 2012 013 641.2

(51) Int. Cl. B04B 5/04

(52) U.S. Cl. CPC B04B 5/0414; B04B 2005/0435
USPC 494/16

(57) ABSTRACT

The invention relates to an adapter for a centrifuge vessel having a shell-shaped base body formed as one piece and delimiting a cavity for the purpose of accommodating the centrifuge vessel and comprising a base region and an adjacent side-wall region of which the top edge defines the opening edge of the cavity, at least one expansion joint being present in the side-wall region, which expansion joint when subjected to a force allows for moving the side-wall region from a starting position to an expanded position such that the length of the opening edge is greater in the expanded position than in the starting position. The adapter is made of a plastics material such that when the force is removed from the side-wall region the base body automatically returns to the starting position.

### CROSS-REFERENCE TO RELATED APPLICATIONS

This application is a submission under 35 U.S.C. §371 of International Application No. PCT/EP2013/002011, filed Jul. 8, 2013, which claims priority to German Application No. 10 2012 013 641.2, filed Jul. 9, 2012, the disclosures of which are hereby expressly incorporated by reference herein in their entireties.

### FIELD OF THE INVENTION

The present invention relates to an adapter for a centrifuge vessel.

### BACKGROUND OF THE INVENTION

Centrifuge vessels, for example, centrifuge bottles, are special containers which comprise a vessel body and either a sealable or a non-sealable opening and which are adapted for use in a centrifuge for the purpose of accommodating and separating samples. In a centrifuge, substance mixtures are separated by implementation of high acceleration forces. To this end, a mixture to be separated is placed in a centrifuge vessel, which is then driven so as to rotate in such a manner that centrifugal forces occur within the centrifuge vessel to cause separating processes to take place. By this means, individual liquids may be separated from each other or solid particles from a liquid. On account of the high acceleration values, very high forces act on the centrifuge vessel and its contents, so that the centrifuge vessels must show a high degree of mechanical stability or must be stabilized.

There are various types of centrifuge vessels, for which reason adapters are used to fit the different geometries of centrifuge vessels to a centrifuge holding means. The centrifuge vessels are accommodated in the centrifuge adapter and the adapter is mounted on the centrifuge rotor's holding means, which is driven so as to rotate during a centrifuging operation.

It is desirable for the walls of the centrifuge vessels used for the accommodation of samples to be as thin as possible for reasons of weight and the reduction of overall costs. This, however, results in a loss of stability of the centrifuge vessel—often to such an extent that they are no longer self-supporting. The same problem occurs with respect to sample bags as used, for example, for centrifuging blood. In the case of such centrifuge vessels, the adapters themselves will also serve to support the vessels so as to maintain their shape.

Furthermore, increasingly larger centrifuge vessels are being used for the purpose of achieving more efficient centrifugation. Every centrifuging operation is set to a predetermined time limit, so that centrifuge vessels of the largest possible capacity are used to save batch time and reduce overall costs. Due to the high acceleration forces that occur during centrifugation, however, enormous forces are liberated, which act on both the centrifuge vessel and on the adapter. As a result, the centrifuge vessel and the adapter may be deformed to such an extent that they can hardly or not at all be separated from each other. Furthermore, there is the possibility of an increased risk of injury occurring during removal of the centrifuge vessel, since the centrifuge vessel and the adapter will have become firmly wedged together to render them less readily separable. There is also the added possibility of the deformed centrifuge vessel being no longer reusable, which increases the costs of the process of centrifugation. Due to the above risks, centrifuge vessels of a larger volume are usually restricted as to acceleration, which, however, is concomitant with a reduction in separation efficiency.

Thus, it is the object of the present invention to avoid problems incurred in the prior art and to provide an adapter for a centrifuge vessel which can withstand high acceleration values during centrifugation and which is also capable of stabilizing centrifuge vessels having comparatively thin walls and from which the centrifuge vessel can nevertheless be readily removed following a centrifuging operation.

### SUMMARY OF THE INVENTION

In its broadest aspect, the present invention therefore relates to an adapter for a centrifuge vessel, which adapter comprises a shell-like base body formed as a single piece and delimiting a cavity provided to accept the centrifuge vessel, and also comprising a base region and an adjoining side-wall region, the top edge of which defines the opening edge of the cavity, said side-wall region comprising at least one expansion joint that allows the side-wall region to be expanded from a starting position to an expanded position by means of an applied force such that the length of the opening edge is larger in the expanded position than in the starting position. The adapter is made of a plastics material adapted to cause the side-wall region to return automatically to the starting position upon removal of said force. A return to the starting position may also be understood to involve recoiling to an extent that the outer diameter of the basic adapter body will differ in the recoiled position from the original outer diameter at the same location by an amount of up to ±10%, preferably by a maximum of ±5%, more preferably by not more than ±2%, and very preferably by a maximum of ±1%.

On the one hand, the design of the adapter according to the present invention allows for easy removal of a centrifuge vessel, in a very simple manner, in that the opening edge of the cavity accommodating the centrifuge vessel is expanded by the application of a force. This is only possible due to the provision of an expansion joint in the side-wall region of the adapter and due to the adapter itself being of a plastics material having elastic properties enabling it to return to its starting position. The combination of said properties allows for an increase in the length of the opening edge without it being necessary to provide the adapter with any folding or opening devices.

There is, furthermore, no need for any closing or holding devices for keeping the adapter in its starting position without expansion of the opening edge. Recoiling from the expanded position to the starting position takes place solely on account of the recoiling force embodied in the adapter due to its design as a single piece and to the material thereof. This has the added advantage of the possibility of holding the centrifuge vessel securely inside the adapter, while it is stabilized at all times due to the adapter being in the non-expanded starting position as long as that the opening edge is not specifically expanded by application of force. The length of the opening edge in the starting position is appropriately selected such that the top edge of the side-wall region delimiting the cavity in the starting position is closely adjacent to the centrifuge vessel. This, in combination with the shell-like structure of the basic adapter body formed as a single piece, the cavity of which is adapted to the outer shape of the accommodating centrifuge vessel in a manner known per se, results in perfect support of the accommodated vessel, even when said vessel is of only very small wall thickness. Even when exposed to high centrifugal forces, for example, forces ranging from 5,000 to 10,000 g, the elastic properties of the adapter allow for adaptation thereof to the centrifuge vessel contained therein and also to a holding device, for example, a centrifuge cup or swinging bucket or the like, accommodating the adapter and serving to attach it to the centrifuge rotor. The holding device further stabilizes the outer circumference of the adapter during the centrifuging operation and thus prevents excessive expansion of the adapter. Due to its elastic properties, however, the adapter is able to adapt its outer circumference to the contact surface of the holding device and can thus be supported thereby.

There is, furthermore, no need to trigger any holding mechanisms for the purpose of removing the centrifuge vessel from the adapter. No tools are required, since the user can, for example, both expand the adapter and remove the centrifuge vessel by hand. This is readily possible even in the event of the centrifuge vessel becoming deformed during centrifugation, though such deformation will be relatively slight due to the flexibility and the absorptive properties of the adapter. Because of the elastic properties of the adapter and the presence of the expansion joint, excessive force is not necessary in order to facilitate bending of the adapter away from the centrifuge vessel and to ease it open for the purpose of effecting unhindered separation of the centrifuge vessel from the adapter and removing it therefrom. Thus, the risk of incurring damage to the centrifuge vessel and/or to the adapter, or of the user being injured is therefore extremely low. Consequently, the adapter and centrifuge vessel have an increased lifespan. Due to the high level of support, even large and/or thin-walled centrifuge vessels having, for example, a capacity of up to 3000 ml, can be used at high rotational speeds. The throughput and separation efficiency are thus improved.

Within the scope of the present invention, an expansion joint is defined as being any kind of recess in the material of the side-wall region that enables movement of segments of the side-wall region relatively to one another. The expansion joint is preferably configured as a recess, more particularly, as a slit traversing the thickness of the wall. It is also possible for multiple recesses to be combined to form an expansion joint. In one possible embodiment, the expansion joint is a recess, more particularly, a straight slit, extending from the top edge of the side-wall region toward the base region. The expansion joint thus divides the side-wall region into two segments capable of being separated from each other, starting at the top edge delimiting the cavity and thereby increasing the length of the opening edge. The length of the opening edge is measured along the inner edge of the side-wall region immediately adjacent to the cavity, wherein in an expanded state the shortest distance between the endpoints of the inner edge separated by the expansion joint is taken into account. Said two endpoints are positioned closer to one another in the starting position than in the expanded position. The expansion joint appropriately extends downwardly from the opening edge toward the base region of the adapter to such an extent that the sections of the side-wall region can be moved sufficiently far from each other to enable easy removal of the centrifuge vessel from the adapter. The expansion joint preferably extends into the edge of the base region of the adapter. This is advantageous, because, on the one hand, the long expansion joint allows for easy expansion of the adapter and, on the other hand, the bend between the base region and the side-wall region of the adapter provides increased tension when expanded and thus an increased force for effecting recoiling to the starting position.

In an alternative embodiment, the expansion joint comprises an indenture extending from the top edge to an upper side-wall region of the adapter. Additionally, there is at least one recess extending to the side of the indenture and displaced therefrom toward the base region in such a way that a web-like region is formed between the indenture and the recess. Upon expansion of the adapter, said bar-like region can lift horizontally and thus cause an enlargement of the opening edge. The recess may preferably be configured so as to be bow-shaped, where the term “bow-shaped” includes not only rounded but also angular shapes. The bow-shaped recess is preferably disposed below the indenture in such a manner that the latter is positioned approximately centrally above the bow. This results in a bowed or angular bar-like region between the indenture and the recess that may be twisted into a horizontal direction, thus resulting in expansion of the opening edge. In one development, the bow-shaped recess can join a slit-like recess extending toward the base region, resulting in a basically forked or Y-shaped expansion joint. The latter further facilitates expanding of the side-wall region and thus simplifies removal of the centrifuge vessel from the adapter.

Instead of a bow-shaped recess, recesses may be provided on each side of the indenture. Such recesses may extend parallel to or at an angle to either each other and/or to the indenture. In either case, bar-like regions are created, effecting expansion of the opening edge by means of twisting. Again, the recesses are preferably slit-like, but other shapes are permitted as long as the adapter's stability is sufficiently maintained. The indentures can be of any shape, for example, slit-like or wedge-shaped. Their length depends on the extent of expansion of the opening edge to be achieved.

Although a single expansion joint in the side-wall region of the adapter may be sufficient for the purpose of achieving the object of the present invention, it is preferable to provide more than one expansion joint, since this eases handling of the adapter. For example, two to four expansion joints, preferably evenly spaced, are provided in the peripheral direction of the side-wall region. These expansion joints may be of the same or of different type. The expansion joints separate the side-wall region of the adapter into a number of segments, preferably of the same type, that are, however, all part of the single-piece basic adapter body and are connected thereto via the base region.

The base region and the side-wall region of the adapter are disposed at an angle to each other. A rounded transition region is preferably located between them. The curve of the transition region may contribute to an increase in recoiling force, by means of which the side-wall region moves back to the starting position from the expanded position, as adopted contrarily to said curvature. Furthermore, in the event of a side-wall segment being pulled outwardly and simultaneously flattened contrarily to said curvature, tension is built up in this area toward the perimeter of the shell-like basic adapter body due to the curvature of the side-wall region.

Reinforcing ribs may be provided on the exterior surface of the base body for the purpose of stiffening the adapter and simultaneously increasing the recoiling properties. These ribs preferably extend from the side-wall region via the transition region to the base region. A further advantage of the ribs is the reduced contact area of the adapter against the holding means accommodating the adapter. The ribs can easily adapt to the contact area of the holding device and can be readily detached therefrom. Since the reinforcing ribs are also of a flexible material forming part of the single-piece basic adapter body, they are able to provide a mechanical damping effect which makes them capable of absorbing additional forces during the centrifuging process. It is also possible for the ribs to define an external geometry of the adapter. In this regard, the shape of the centrifuge vessel—and, thus, the shape of the adapter cavity accommodating said vessel—may differ from the outer shape of the adapter. Whereas, for example, the cavity may accommodate a centrifuge vessel of a circular or oval cross-section, the centrifuge holding means may have an angular basic shape, reproduced by the reinforcing ribs. To this end, a number of reinforcing ribs may be disposed in particular in the corner regions of the receptacle.

In order to remove the adapter and to expand it very easily, at least one handle protrusion, for example, in the form of a pin, is suitably provided in a top marginal region of the base body. This facilitates opening of any partial segment of the side wall and the removal of the centrifuge vessel from the adapter cavity. The handle protrusion may be integrally joined to the base body or connected thereto as a separate piece. The former option is preferred.

To ensure the recoiling properties, the basic adapter body is appropriately of a flexible, more particularly, elastomeric, plastics material. This can be basically any suitable plastics material which has the stiffness required to accommodate a centrifuge vessel disposed in the cavity in the starting position and to keep it stable, but which is sufficiently mechanically flexible in order to be bent into the expanded position for the purpose of removing the vessel and to subsequently recoil to the starting position upon removal of such an expanding force. The precise mechanical properties, for example, shape retention and elasticity, are, for example, dependent on the dimensions of the adapter and on the type and size of the centrifuge vessel to be accommodated therein. Self-supporting centrifuge vessels require less support from the adapter than non-self-supporting centrifuge vessels of reduced wall thickness, for example, blood bags. Furthermore, plastics materials adequately resistant to chemicals are preferred, in case they come into contact with leaky samples. Thermally resistant plastics materials that can be used both in cooled centrifuges and at elevated outside temperatures are also advantageous. Injection-moldable plastics materials are preferably used, as these are particularly suitable for the manufacture of the single-piece basic adapter body. In the event of the entire adapter being made as a single piece, as is preferred, it appropriately consists entirely of injection-molded plastics material and is manufactured by means of injection-molding. In this regard, the elastomeric plastics materials are all plastics materials capable of elastic deformation, namely homopolymers, copolymers, and polymer blends, with or without fillers, i.e. minerals or fibers. They particularly include thermoplastic elastomers. Specific examples of suitable and preferred plastics materials are polyolefins, more particularly, polypropylenes, or polyamides. Blends or copolymers of such plastics materials may also be used.

### BRIEF DESCRIPTION OF THE DRAWINGS

The present invention is explained in greater detail below with reference to exemplary embodiments. However, the present invention is not restricted to these exemplary embodiments, and other combinations and applications are therefore possible. In the following diagrammatic drawings, in which like parts are identified by like reference numerals:

FIG. 1 shows an exemplary embodiment of an adapter comprising a centrifuge vessel and a centrifuge holding means;

FIG. 2 is a perspective view of the exemplary embodiment of the adapter as shown in FIG. 1;

FIG. 3 shows the adapter as shown in FIG. 1 and FIG. 2 during the removal of the centrifuge vessel from the adapter following a centrifuging operation;

FIG. 4 is a perspective view of a second exemplary embodiment of an adapter;

FIG. 5 is a perspective view of a third exemplary embodiment of an adapter; and

FIG. 6 is a perspective view of a fourth exemplary embodiment of an adapter.

### DETAILED DESCRIPTION OF THE INVENTION

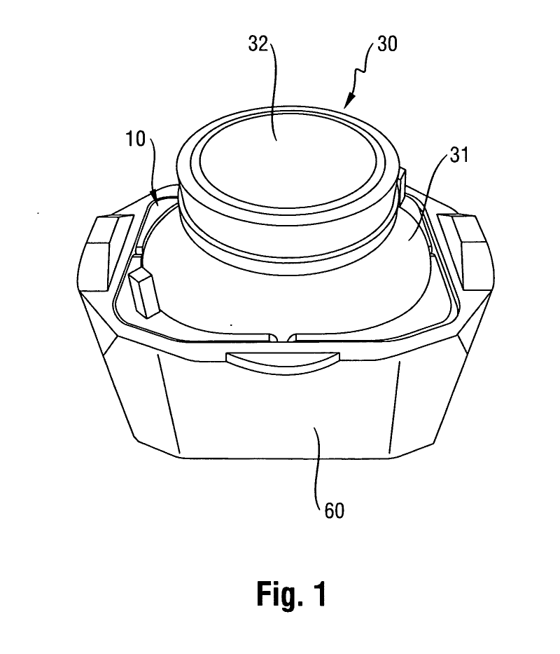

FIG. 1 shows an exemplary embodiment of an adapter 10 with a centrifuge vessel 30 accommodated therein. The centrifuge vessel 30 is in the form of a bottle comprising a vessel body 31 and a closing element 32 in the form of a screw-on lid. The adapter 10 and the centrifuge vessel 30 are accommodated in a centrifuge holding means 60, which may be mounted on a centrifuge rotor such that the centrifuge holding means 60, the adapter 10, and the centrifuge vessel 30 are jointly accelerated in the centrifuge to enable the contents of the sealed centrifuge vessel 30 to be centrifuged. The process of centrifugation may be used for separating, say, two or more different fluids from each other or suspended solid particles from a fluid, within the centrifuge vessel 30.

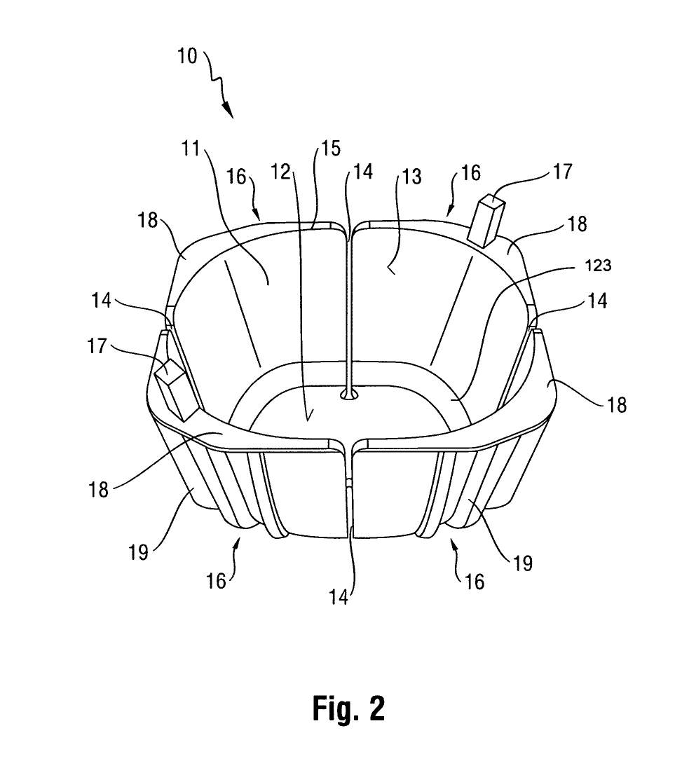

FIG. 2 shows the adapter 10 depicted in FIG. 1 in a perspective view. The adapter 10 has a shell-shaped or cup-shaped base body comprising a base region 12 and a side-wall region 13 connected to each other via a curved transition region 123. The base region and the side-wall region delimit a cavity 11 serving to accommodate the centrifuge vessel 30. The base body comprises four expansion joints in the form of slit-shaped recesses 14 extending from an edge of the base region 12 via transition region 123 and side-wall region 13 to a top edge 15 of the side-wall region 13 of the adapter 10. The top edge 15 is the top boundary of the side-wall region 13 and the inside edge of the top marginal region 18. The side-wall region 13 is subdivided into four parts or segments 16 by means of four recesses 14, connected to each other via the base region 12.

Pin-like protrusions 17 are integrally connected to the rest of the adapter on two opposing segments 16 in the top marginal region 18 of the side-wall region 13. By means of said protrusions, it is possible to pull the segments 16 outwardly so as to increase the length of the opening edge defined by the top edge 15 and also to enlarge the opening cross-section of the cavity 11.

Reinforcing ribs 19 are formed on the outer surface of the adapter. These extend from the top marginal region 18 along the side-wall region 13 via the transition region 123 down into the base region 12 and serve to stiffen the adapter. Additionally, they facilitate fabrication of the adapter by injection molding, improve the adaptability of the adapter to the contact area of the centrifuge holding means 60, and facilitate the removal of the adapter therefrom.

The adapter 10 is formed as a single piece and is made of an elastomeric plastics material, for example, polypropylene or polyamide, preferably fiber-reinforced polyamide by, for example, injection molding. The plastics material is flexible such that the four segments 16 are moveable relatively to each other for the purpose of accommodating the centrifuge vessel 30 (see FIG. 1) prior to the centrifuging operation and for the purpose of releasing it following the centrifuging operation. As described above, movement of the segments 16 relatively to each other is advantageously effected with the aid of the pin-shaped protrusions 17. The pin-shaped protrusions 17 are also used for the purpose of removing the adapter 10 from the centrifuge holding means 60. Such a holding means may be in the form of a centrifuge cup of a swinging bucket rotor. It is also possible to remove the adapter 10 together with the vessel 30 from the cup by means of the pin-shaped protrusions 17.

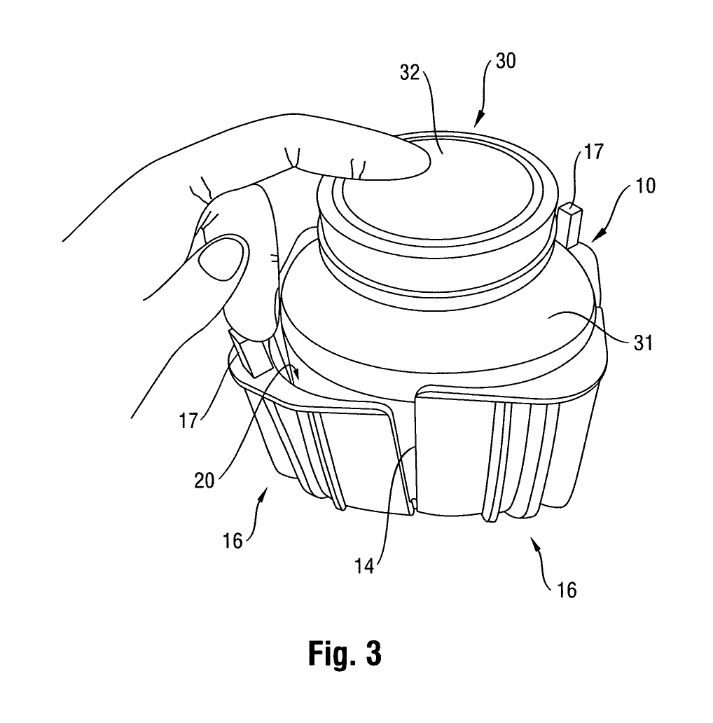

FIG. 3 shows the adapter 10 illustrated in FIG. 1 and FIG. 2 with a centrifuge vessel 30 accommodated therein following a centrifuging operation. In order to remove the centrifuge vessel 30 with its vessel body 31 and its lid 32 from the adapter 10, one of the segments 16 of the adapter 10 may be bent elastically outwardly so as to form a clearance 20 between the centrifuge vessel 30 and the adapter 10. The clearance 20 is formed by the user pulling the pin-shaped protrusion 17 outwardly with one finger. The opening cross-section of the cavity 11 is thereby enlarged and the length of its opening edge increased. At the same time, the side-wall region 13 of the bent segment 16 detaches from the wall of the centrifuge vessel 30 and the centrifuge vessel can easily be removed from the adapter 10. When the user releases the adapter following removal of the vessel so as to remove the force applied to the pin-shaped protrusion 17, the adapter automatically returns from the expanded position shown in FIG. 3 to the starting position shown in FIG. 2. On the one hand, this is achieved by way of the intrinsic recoiling force applied by the elastic plastics material and, on the other hand, by means of the shape of the adapter. The curved form of the side-wall region 13 toward the perimeter and of the transition region 123, and the curvature of the reinforcing ribs 19 toward which a force has to be applied upon bending the sector 16, cause recoiling of the segment 16 to the starting position, where the inner wall surfaces of the adapter bear against the outer wall of the centrifuge vessel and support it.

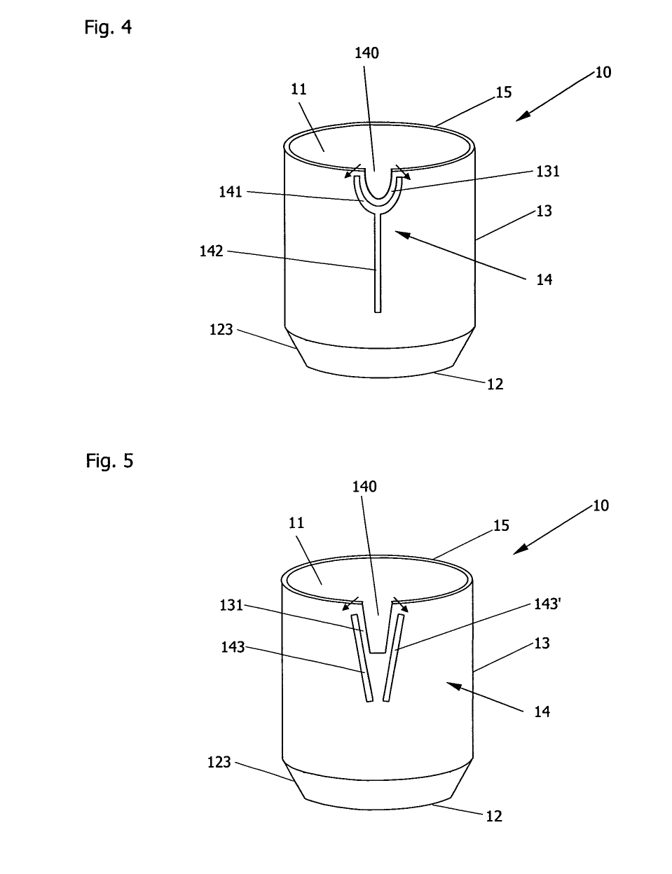

FIG. 4 shows a further embodiment of an adapter according to the present invention. This differs from the adapter shown in FIGS. 1 to 3 mainly as regards the design of the expansion joint 14. This is, in this case, in the form of a fork or “Y” and consists of a bow-shaped recess 141, to which a slit-like recess 142 is connected in the crown region of the bow. The bow-shaped part 141 encompasses a tongue-shaped incision 140 extending from the top edge 15 to the side-wall section 13 of the basic adapter body. A web-like region 131 remains between the incision 140 and the recess 141. If the marginal region of the adapter is moved outwardly toward the arrows, which can again be effected by means of pin-shaped protrusions (not shown), the web-like region 131 twists, the opening cross-section of the cavity 11 expands, and the side wall section 13 is pushed outwardly in the region of the expansion joint 14. This facilitates the insertion and removal of a centrifuge vessel (not shown).

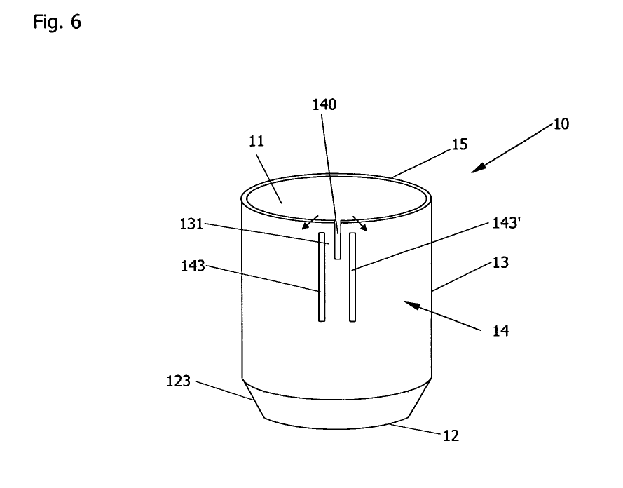

The adapters shown in FIGS. 5 and 6 function in a similar manner. In the case of the adapter shown in FIG. 5, the web-like regions 131 are formed between a trapezoid incision 140 and two slit-shaped recesses 143 and 143′ extending alongside its sides and downwardly staggered in relation thereto toward the base region 12. The adapter shown in FIG. 6 comprises three slit-like recesses 140, 143, and 143′ extending parallel to each other and forming two web-shaped regions 131.

Other embodiments of an adapter are conceivable, for example, adapters for various sizes and geometries of centrifuge vessels and also adapters for various types of centrifuges and their centrifuge holders. Typical centrifuge vessels have capacities of from, say, 100 ml to 3000 ml.

While the present invention has been illustrated by description of various embodiments and while those embodiments have been described in considerable detail, it is not the intention of Applicants to restrict or in any way limit the scope of the appended claims to such details. Additional advantages and modifications will readily appear to those skilled in the art. The present invention in its broader aspects is therefore not limited to the specific details and illustrative examples shown and described. Accordingly, departures may be made from such details without departing from the spirit or scope of Applicant's invention.

What is claimed is:

1. An adapter for a centrifuge vessel, comprising:
a shell-shaped base body formed as a single piece and delimiting a cavity for accommodating the centrifuge vessel, said base body having a base region and an adjacent side-wall region having a top edge that defines an opening edge of said cavity;
at least one expansion joint provided in said side-wall region,
wherein said at least one expansion joint, when subjected to a force, allows for moving said side-wall region from a starting position to an expanded position such that a length of the opening edge is greater in the expanded position than in the starting position,
and further wherein said base body is made of a plastics material such that when the force is removed from said side-wall region, the base body automatically returns to said starting position.

2. The adapter according to claim 1, wherein said at least one expansion joint is a recess which extends from said top edge toward said base region.

3. The adapter according to claim 1, wherein said at least one expansion joint includes an incision extending from said top edge to an upper side-wall region, and at least one recess extending to the side of said incision and staggered therefrom toward said base region such that between said incision and said recess there is formed a web region.

4. The adapter according to claim 3, wherein said recess is bow-shaped.

5. The adapter according to claim 4, wherein said bow-shaped recess is adjoined by a slit-shaped recess extending toward said base region.

6. The adapter according to claim 3, wherein a recess is respectively disposed to each side of said incision.

7. The adapter according to claim 1, wherein a plurality of expansion joints are provided in said side-wall region.

8. The adapter according to claim 1, wherein a curved transition region is provided between said base region and said side-wall region.

9. The adapter according to claim 1, wherein reinforcing ribs are formed on the outside of said base body.

10. The adapter according to claim 1, wherein said base body has at least one handle protrusion projecting from an upper edge region.

11. The adapter according to claim 1, wherein said plastics material is a flexible plastics material.

12. The adapter according to claim 11, wherein said plastics material is an injection moldable plastics material.

13. The adapter according to claim 2, wherein said recess is in the form of a straight slit.

14. The adapter according to claim 2, wherein said recess extends from said top edge to an edge of said base region.

15. The adapter according to claim 7, wherein two to four expansion joints are provided in said side-wall region.

16. The adapter according to claim 15, wherein said two to four expansion joints are uniformly distributed about the perimeter of said side-wall region.

17. The adapter according to claim 11, wherein said plastics material comprises an elastomeric plastics material.

18. The adapter according to claim 17, wherein said elastomeric plastics material comprises a polyolefin.
